(19) United States
(12) Patent Application Publication
(10) Pub. No.: US 2025/0088757 A1
(43) Pub. Date: Mar. 13, 2025

(54) METHOD AND APPARATUS FOR CAPTURING AN IMAGE OUTSIDE A MOTOR VEHICLE, AND MOTOR VEHICLE

(71) Applicant: Continental Automotive Technologies GmbH, Hannover (DE)

(72) Inventor: Thomas Smits, Straelen (DE)

(73) Assignee: Continental Automotive Technologies GmbH, Hannover (DE)

(21) Appl. No.: 18/882,510

(22) Filed: Sep. 11, 2024

(30) Foreign Application Priority Data
Sep. 12, 2023 (DE) 10 2023 208 845.2

(51) Int. Cl. H04N 23/81; B60R 1/23; H04N 7/18; H04N 23/60

(52) U.S. Cl. CPC H04N 23/81; B60R 1/23; H04N 7/183; H04N 23/64; B60R 2300/307

(57) ABSTRACT

A method and an apparatus for capturing an image outside a motor vehicle and also a motor vehicle having such an apparatus are disclosed. The disclosure provides for the method to comprise the following steps: capturing an image outside a motor vehicle using a camera device, the captured image being distorted due to the nature of the camera device, capturing a property of the camera device, equalizing the image based on the property of the camera device, checking the equalized image based on the property of the camera device, and providing the equalized image to a user of the motor vehicle.

### CROSS REFERENCE TO RELATED APPLICATIONS

This U.S. patent application claims the benefit of German patent application No. 10 2023 208 845.2, filed Sep. 12, 2023, which is hereby incorporated by reference.

### TECHNICAL FIELD

The disclosure relates to a method and to an apparatus for capturing an image outside a motor vehicle and also to a motor vehicle having such an apparatus.

Motor vehicles having confusing attachments that protrude into the road and cannot be seen or can be seen only with difficulty from a driver's seat require electronic monitoring using a camera device. However, such monitoring is particularly computationally intensive, especially if it is intended or has to comply with one or more safety standards.

It is therefore an object of the present disclosure to specify an improved method and an improved apparatus for capturing an image outside a motor vehicle.

This object is achieved by means of the subject matter of the independent claims. Advantageous developments are specified in the dependent claims.

### SUMMARY

According to a first aspect, a method for capturing an image outside a motor vehicle is provided.

Here, the method according to the disclosure comprises the steps of capturing an image outside a motor vehicle using a camera device, the captured image being distorted due to the nature of the camera device, capturing a property of the camera device, equalizing the image based on the property of the camera device, checking the equalized image based on the property of the camera device, and providing the equalized image to a user of the motor vehicle.

The method according to the disclosure is used in particular to provide a simple and cost-effective possible way of being able to check equalization of a camera image for correctness and functionality.

In particular, embodiments of the method according to the disclosure make it possible to recognize or verify an attachment position of a camera device, in particular its orientation and/or position or coordinate system, in particular with respect to the environment of the camera device, and thereby to determine and correct an erroneous attachment, in particular a tilt, displacement, twisting and/or rotation of the camera and/or a mount of the camera device.

The motor vehicle is in particular a vehicle with oversized external dimensions, such as a transport and/or agricultural vehicle, also comprising in particular attachments and/or equipment, such as a trailer, a bucket, a fork, a trough and/or a mowing apparatus, in particular a rotary mower.

For this purpose, at least one image outside the motor vehicle is captured using a camera device. A camera device is an apparatus which is designed to record one or more, in particular contiguous, images of the exterior of the motor vehicle. In particular, the camera device is designed to continuously and/or periodically record images of the exterior, for example in a video or video stream.

For this purpose, the camera device, which can also be referred to as a camera or image capture device, may be arranged or fastened in particular on or near an outer side of the motor vehicle. In this case, the camera device may both be arranged permanently or in a stationary manner on the motor vehicle and be designed to be releasable or removable.

For example, the camera may be positionable or arrangeable in one or more fastening devices such as mounts or receptacles on the outer side of the motor vehicle, in particular on or near an attachment of the motor vehicle and thus as warranted or required.

The camera device is in particular a camera with a special lens or a special objective which generates a non-proportional image, such as a so-called wide-angle and/or fisheye lens, which may have an opening or image angle of at least 180°, 200°, 220°, 240°, 260°, 280° or more. This means that the image captured by the camera device is distorted and/or misrepresented, in particular misrepresented in a manner curved and/or barrel-shaped and/or fish-eye-shaped at least in sections.

In a further step, at least one property of the camera device is captured.

A property may also be referred to as the context of the camera device and characterizes or defines one or more parameters of the camera device, such as type or nature, location and/or capturable image section or angle of the camera or the lens used, as will be described below. In particular, the property comprises an indication or an assignment to a type and/or severity of a distortion of the recorded image and/or an orientation, tilt, displacement, twisting and/or rotation of the camera device.

The property may be captured here in particular by way of communication of the camera device with a control device, which in particular carries out this and the steps of the method described below and can also cause or trigger the capture of one or more images by the camera device.

For example, the camera may provide its own parameters and in particular those of the installed lens to the control device. In addition, suitable sensors can detect a location of the camera, such as short-range sensors, in particular NFC and/or RFID sensors, which are installed on or in a mount and communicate with the control device.

Alternatively or additionally, a code arranged in or on the mount or near the latter, such as a barcode or QR code, may also be read by the camera device, which allows an indication of the location of the camera device. In this case, the camera device and the control device can communicate with one another both in a wired manner and wirelessly and may provide the properties of the camera device.

Likewise, the property may also be captured by the camera device or the control device itself, for example because the image or the captured image section is analyzed and thus conclusions on a position and/or an attachment location of the camera device are drawn.

In this case, the step of capturing the property may be carried out before, during or after capturing the image(s). In particular, this step is carried out initially, i.e. before the first image is captured by the camera device.

Optionally, an image section may be selected from the captured image, which image section comprises only a partial area or a partial quantity of the captured image, for example a certain opening angle, in particular a certain horizontal and/or vertical opening angle of the total possible opening angle. For example, only a horizontal opening angle of 30° and a vertical opening angle of 20° are selected. This may be done, for example, by cutting and/or cropping. The image section may also be selected here in particular on the basis of the property of the camera device.

The image or the image section is equalized based on the captured property of the camera device.

In this case, the image captured and distorted due to the camera property is equalized, specifically in particular in such a way that a previously distorted or misrepresented image, in particular a strongly barrel-distorted image and/or an image distorted in a fisheye-shaped manner, as captured by the camera device, is imaged onto an undistorted or misrepresentation-free image, in particular a gnomonic, rectilinear, orthographic and/or angle-accurate image. To do this, image processing algorithms are used to edit, arrange and organize the picture elements or pixels in such a way that an equalized image is created.

How exactly the distorted image is equalized may be done in particular by the control device accessing a database in which one or more instructions for equalization based on the respective camera property are stored. For example, predefined equalization routines or instructions are stored in this database for a plurality of camera types, lens types and/or attachment locations, on the basis of which the image may then be equalized.

In this case, the database may be arranged or stored both on or in the camera device and on or in the control device. Alternatively or additionally, the database may also be stored on a remote computing unit, from which it may be retrieved wirelessly if required.

Optionally, after the property of the camera has been identified, it may be provided to a user, in particular a driver, of the motor vehicle, in particular for verification of the captured property. This may be provided, for example, on an output device such as a display device, for example a monitor or display, which is arranged in particular in the interior of the motor vehicle and is visible from a driver's seat during operation of the motor vehicle. Together with the property of the camera, a property of an attachment, which appears at least partially in the captured image, may also be provided.

The equalized image is checked here based on the property of the camera device.

A check may be carried out here in particular using suitable image evaluation algorithms, such as image comparison algorithms. This checks whether individual or a plurality of elements in the image correspond to predefined elements, as will be explained below. In particular, it is checked whether the equalization has been carried out properly or correctly and that no errors have occurred in the equalization. This may be done based on criteria defined in the properties of the camera device.

The equalized image is provided to a user of the motor vehicle.

Thus, the equalized image is output to a user. In particular, the equalized image is only provided to a user if the check is positive or if the equalization is identified as correct. Alternatively, the image can also be provided if the check is negative or the equalization is identified as erroneous or incorrect, in which case optionally an indication of the negative check or the error and in particular its degree may be provided. The output may be provided here, for example, on an output device, as described above.

The solution according to the disclosure makes it possible to provide a simple and fast possible way of verifying or checking an equalization process or algorithm.

According to one development, the method further comprises the step of enabling a function of the motor vehicle depending on the check.

If the check reveals that the equalization has been carried out properly or correctly, a function of the motor vehicle may be enabled. If, on the other hand, the check reveals that the equalization has not been carried out properly or correctly, for example because deviations or changes in the equalized image have been detected in relation to the properties, a function of the motor vehicle cannot be enabled, or may be blocked or restricted. In particular, this may also be done together with information provided.

The function may be in particular a function of the motor vehicle that is performed by an element which is at least partially arranged in the field of view or the image section, which reproduces the image of the camera device.

In particular, the function is a function with respect to an attachment and/or an item of equipment, such as a trailer, a bucket, a fork, a trough and/or a mowing apparatus, and in particular such an element which is arranged on the motor vehicle in such a way that it cannot be seen or viewed or at least not completely seen or viewed from the driver's seat.

For example, it is a bucket, fork, trough or mowing apparatus that protrudes far ahead of the motor vehicle and protrudes into the intersecting road, especially at narrower intersections and/or intersections that are difficult to see.

Again, for example, it is a trailer whose rear end, especially when reversing, cannot be overlooked by the driver to such an extent that he may safely start or continue a journey.

This function may then be blocked if the user or driver falsifies the provided image with his user input, i.e. does not enable it. For example, actuation of the attachment may be restricted or prevented, or forward and/or reverse travel, i.e. a start of travel as such, can be prevented or only allowed at a restricted speed, for example walking speed, in particular less than 30 km/h, 10 km/h, 5 km/h or 3 km/h.

This development makes it possible to make the operation of the motor vehicle particularly safe, especially with an attachment.

According to one development, the checking comprises checking image features.

For example, an image feature comprises here an element captured or represented in the image. Individual or all image features may be extracted here from the image, for example by way of suitable image recognition algorithms, in particular from the field of pattern recognition.

These features may then be compared with features stored or defined in the camera properties, in particular from the database. For example, one or more features in the image should have a predefined shape, size and/or position in the image, which may then be tested by checking for correctness.

In particular, it is possible to check for one or more characteristic contours in the image. A characteristic contour in the image is in particular a line and/or edge of a component of the motor vehicle, such as a body part, in particular a fender, a hood, a rear cover, a pillar, in particular an A-, B- and/or C-pillar, and/or a roof, which has a clear line.

One or more of these characteristic contours are checked here for their correct position in the image. In particular, it is checked whether a line and/or surface coincide(s) with a predefined line and/or surface, in particular in a previously described overlay image. In particular, the check is designed in such a way that it checks one or more of these characteristic contours with a tolerance of less than 5 pixels, 3 pixels, 2 pixels, 1 pixel and/or with pixel exactness or pixel accuracy.

This development enables a particularly simple and fast check.

According to one development, the checking is carried out in a functionally safe area.

A functionally safe area relates here to hardware and/or software that is used in the motor vehicle and has been verified as particularly functionally reliable, for example in accordance with a standard and/or certification. For example, the functionally safe area is an area that is certified according to the ASIL standard, especially according to ASIL-A and/or ASIL-B.

In particular, the check is carried out exclusively in a functionally safe area, whereas further steps, in particular the equalization, of the method according to the disclosure are not processed or carried out in a functionally safe area, i.e. are processed or carried out with conventional hardware or software.

Moreover, in particular, only the checking of image features is performed in the functionally safe area. In particular, the detection or extraction of the features from the captured image is not performed in the functionally safe area.

This development enables a particularly safe implementation of the method.

According to one development, the checking is carried out using artificial intelligence.

Here, artificial intelligence is a computer-aided function approximation that performs or at least supports the checking. In particular, this may be an artificial neural network (ANN).

In particular, the artificial intelligence was trained specifically for the check and the feature comparison. This may be carried out in particular by means of so-called overlay images, in which individual elements or features are highlighted, in particular in color, with the aid of actual, real images which correspond to the image to be checked and/or with the aid of CAD data. Here, these overlay images may either be placed on the equalized image by the camera device or alternatively may first be pre-distorted, placed on the distorted image of the camera device and may then be equalized together. Alternatively or additionally, the artificial intelligence may also be carried out with real images and in particular an actual arrangement of the camera device and/or the attachment on the motor vehicle.

This development enables a particularly reliable check.

According to one development, the camera property comprises a model of the camera device.

A model of the camera device comprises in particular a property, type and/or nature of one or more components of the camera device, in particular of the sensor and/or the objective or the lens, such as a manufacturer, type, production model and/or period.

In particular, the model of the camera device comprises a focal length and/or an opening angle of the objective or the lens.

The model of the camera device may also comprise data or information about the housing and/or a fastening device of the camera device, in particular data from a simulation and/or production, for example so-called CAD data, i.e. data derived from a computer-aided design and substantially corresponding to the actual values and, in particular, dimensions of the camera device and/or the fastening device.

In particular, the model also comprises a resolution, a format, an aspect ratio and/or a possible image section of the sensor.

This development makes it possible to carry out the equalization and check particularly precisely.

According to one development, the camera property comprises a captured image section.

In particular, the camera property comprises a size, an aspect ratio, a pixel number and/or resolution and/or a color space of the captured image. For example, the camera property contains information about the image section, which is used to equalize and check the image.

This development makes it possible to carry out the equalization and check particularly precisely.

According to one development, the camera property comprises an element captured in the image.

In this case, the element may be in particular an element of the motor vehicle and/or the attachment of the motor vehicle. For example, the element may be a body part, such as one or more fenders, one or more pillars, one or more wheels, and/or one or more trim parts. For example, likewise, the element is a hydraulic cylinder or another element or another component of an attachment.

This development makes it possible to carry out the equalization and check particularly precisely.

For carrying out the described steps, it is possible to provide a processor circuit having programming or software comprising program instructions which causes the processor circuit to perform an embodiment of the method when executing the program instructions. The processor circuit may have at least one microprocessor and/or microcontroller for this purpose. The program instructions can be stored in a data memory of the processor circuit.

According to a further aspect, an apparatus is specified which is designed to perform one of the previously described embodiments of the method according to the disclosure.

Here, the apparatus may comprise and/or have access to one or more camera devices. The apparatus may also comprise a control device and a processor circuit, as already described above.

According to a further aspect, a motor vehicle having such an apparatus is specified.

The disclosure also includes developments of the apparatus according to the disclosure and of the motor vehicle according to the disclosure which have features such as have already been described in connection with the developments of the method according to the disclosure. For this reason, the corresponding developments of the apparatus according to the disclosure and the motor vehicle according to the disclosure are not described again here.

For use cases or application situations that may arise in the method and are not explicitly described here, provision may be made for an error message and/or a request for input of user feedback to be output according to the method and/or for a default setting and/or a predetermined initial state to be set.

The disclosure also includes the combinations of the features of the embodiments described.

### BRIEF DESCRIPTION OF THE DRAWINGS

An exemplary embodiment of the disclosure is described below. In this respect:

FIG. 1 shows a schematic plan view of an embodiment of an apparatus for capturing an image outside a motor vehicle and a motor vehicle;

FIG. 2 shows a detailed view from FIG. 1;

FIG. 3 shows a schematic flowchart of an embodiment of an apparatus and a method for capturing an image outside a motor vehicle; and

FIG. 4 shows a schematic flowchart of an alternative embodiment of an apparatus and a method for capturing an image outside a motor vehicle.

### DETAILED DESCRIPTION

The exemplary embodiment explained below is a preferred embodiment of the disclosure. In the exemplary embodiment, the described components of the embodiment each represent individual features of the disclosure that should be considered independently of one another and that each also develop the disclosure independently of one another and can therefore also be considered to be part of the disclosure individually or in a combination other than that shown. Furthermore, the embodiment described may also be supplemented by further features of the disclosure that have already been described.

In the figures, elements with the same function are each provided with the same reference signs.

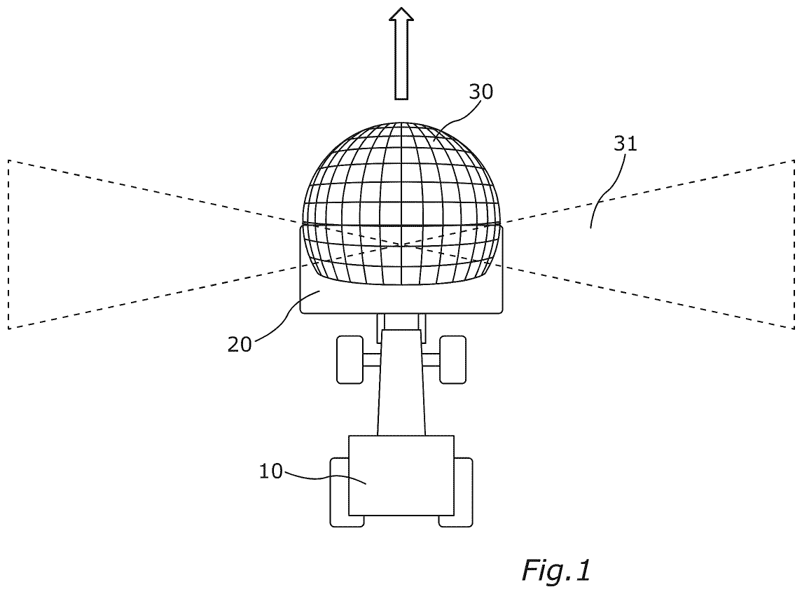

FIG. 1 shows a schematic plan view of an embodiment of an apparatus for capturing an image outside a motor vehicle and a motor vehicle 10.

The motor vehicle 10 moves along a direction of travel, which is indicated by an arrow, and comprises an attachment 20 or an attachment apparatus which is shown here by way of example as a mowing apparatus. The attachment or the attachment apparatus is, by way of example here, a front attachment or a front attachment apparatus.

The motor vehicle 10 also comprises a camera device which is not shown in this FIG. 1 for reasons of clarity. Here, this camera device captures a capture area 30 which is almost spherical and has a capture angle—both horizontally and vertically—of 220°.

In this embodiment shown, the sections indicated by reference sign “31” are relevant here in particular, since they capture an important part of the attachment 20. Here, these sections are still spherically distorted due to the capture area or angle of the camera device.

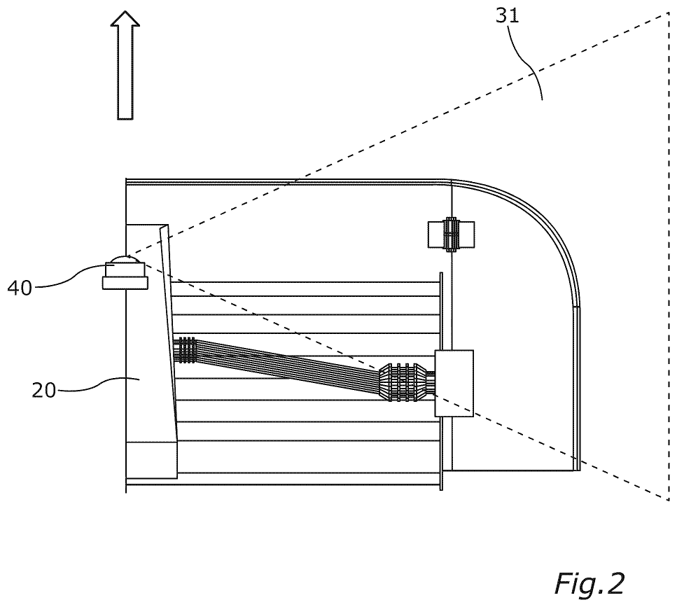

FIG. 2 shows a detailed view from FIG. 1.

In this FIG. 2, the camera device 40 is shown here by way of example with a fisheye lens which captures a right-hand part of the attachment in a section 31.

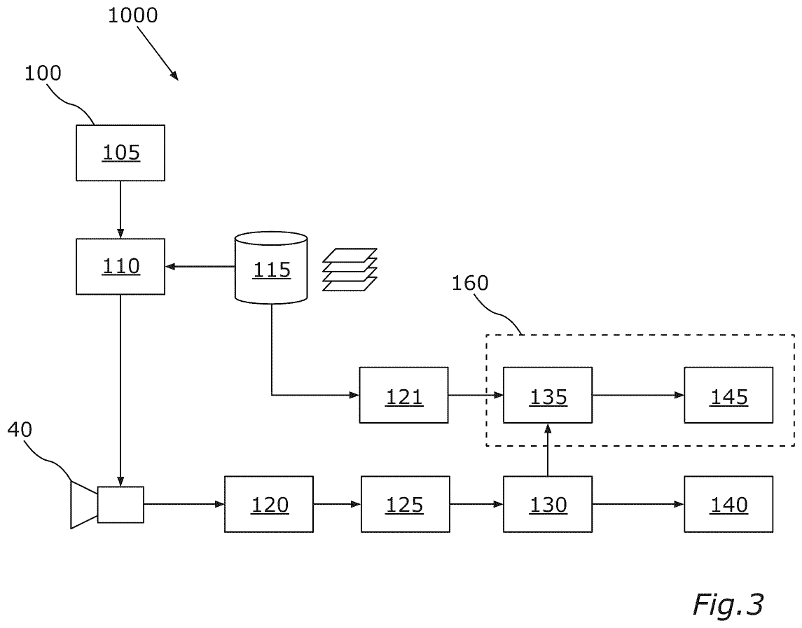

FIG. 3 shows a schematic flowchart of an embodiment of an apparatus 1000 and a method 100 for capturing an image outside a motor vehicle.

Here, the apparatus 1000 carries out the method described below or its steps.

The method 100 according to the disclosure begins with step 105, in which one or more properties or a context of a camera device 40 is/are determined.

In a further step 110, the camera device 40 is configured based on the determined properties. This is effected by accessing a memory or a database 115 in which information about the camera device 40 is stored.

One or more images or a video comprising a plurality of consecutive images of the exterior of the motor vehicle is/are then captured using the camera device 40 in step 120. Here, the images are distorted due to the property of the camera device.

The captured image is then equalized in step 125 using a suitable image equalization algorithm and based on the camera properties, resulting in the equalized image in step 130.

Step 135 detects features in the equalized image based on the features 121 provided from the database based on the camera information.

In step 145, the identified features are then checked.

Here, in this embodiment, both the feature recognition and the check are carried out in a functionally safe area 160.

If the check is then positive, i.e. the equalization is judged to be correct, the equalized image is displayed to a user of the motor vehicle on a display device in step 140. Optionally, in this step 140, a function of the motor vehicle can also be enabled, likewise depending on the check.

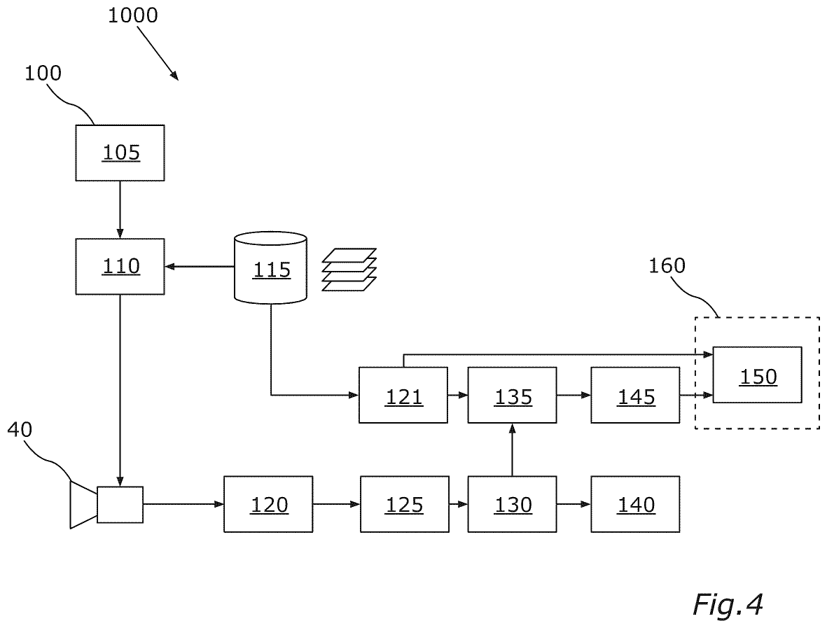

FIG. 4 shows a schematic flowchart of an alternative embodiment of an apparatus 1000 and a method 100 for capturing an image outside a motor vehicle.

This embodiment differs from the embodiment shown in FIG. 3 in particular in that only a partial range of the functions from FIG. 3 are performed in the functionally safe area.

The method 100 according to the disclosure begins with step 105, in which one or more properties or a context of a camera device 40 is/are determined.

In a further step 110, the camera device 40 is configured based on the determined properties. This is effected by accessing a memory or a database 115 in which information about the camera device 40 is stored.

An image or a video comprising a plurality of consecutive images of the exterior of the motor vehicle is then captured using the camera device 40 in step 120. Here, the images are distorted due to the property of the camera device.

The captured image is then equalized in step 125 using a suitable image equalization algorithm and based on the camera properties, resulting in the equalized image in step 130.

Step 135 detects features in the equalized image based on the features 121 provided from the database based on the camera information.

These detected features are then extracted or isolated in step 145.

In step 150, these isolated features are then compared and checked based on the retrieved features 121.

Here, only the step of checking 150 takes place in a functionally safe area 160.

If the check is then positive, i.e. the equalization is judged to be correct, the equalized image is displayed to a user of the motor vehicle on a display device in step 140. Optionally, in this step 140, a function of the motor vehicle may also be enabled, likewise depending on the check.

Overall, the example shows how a method for the cost-effective implementation of functionally safe operation of a camera device on a motor vehicle may be provided.

1. A method for capturing an image outside a motor vehicle, comprising:
capturing an image outside a motor vehicle using a camera device, the captured image being distorted due to the nature of the camera device;
capturing a property of the camera device;
equalizing the image based on the property of the camera device;
checking the equalized image based on the property of the camera device; and
providing the equalized image to a user of the motor vehicle.

2. The method as claimed in claim 1, further comprising:
enabling a function of the motor vehicle depending on the checking the equalized image based on the property of the camera device.

3. The method as claimed in claim 1, wherein the checking the equalized image based on the property of the camera device comprises checking image features.

4. The method as claimed in claim 1, wherein the checking the equalized image based on the property of the camera device is carried out in a functionally safe area.

5. The method as claimed in claim 1, wherein the checking the equalized image based on the property of the camera device is carried out using artificial intelligence.

6. The method as claimed in claim 1, wherein the camera property comprises a model of the camera device.

7. The method as claimed in claim 1, wherein the camera property comprises a captured image section.

8. The method as claimed in claim 1, wherein the camera property comprises an element captured in the image.

9. An apparatus for capturing an image outside a motor vehicle, wherein the apparatus is designed to carry out a method, the method comprising:
capturing an image outside a motor vehicle using a camera device, the captured image being distorted due to the nature of the camera device;
capturing a property of the camera device;
equalizing the image based on the property of the camera device;
checking the equalized image based on the property of the camera device; and
providing the equalized image to a user of the motor vehicle.

10. A motor vehicle comprising an apparatus for capturing an image outside the motor vehicle, wherein the apparatus is designed to carry out a method, the method comprising:
capturing an image outside a motor vehicle using a camera device, the captured image being distorted due to the nature of the camera device;
capturing a property of the camera device;
equalizing the image based on the property of the camera device;
checking the equalized image based on the property of the camera device; and
providing the equalized image to a user of the motor vehicle.
